(19) United States
(12) Patent Application Publication
(10) Pub. No.: US 2021/0047886 A1
(43) Pub. Date: Feb. 18, 2021

(54) NANOCRYSTALLINE TAPES FOR WIRELESS TRANSMISSION OF ELECTRICAL SIGNALS AND POWER IN DOWNHOLE DRILLING SYSTEMS

(71) Applicant: Charalabos Zouboulis, Hannover (DE)

(72) Inventor: Charalabos Zouboulis, Hannover (DE)

(73) Assignee: Baker Hughes Oilfield Operations LLC, Houston, TX (US)

(21) Appl. No.: 16/990,127

(22) Filed: Aug. 11, 2020

Related U.S. Application Data
(60) Provisional application No. 62/886,648, filed on Aug. 14, 2019.

(51) Int. Cl. E21B 7/04; H02J 50/10; H04B 5/02

(52) U.S. Cl. CPC E21B 7/04; H04B 5/0037; H04B 5/02; H02J 50/10

(57) ABSTRACT

Steering assemblies, drilling systems, and method for drilling boreholes are described. The steering assemblies include a first member, an inner transceiver connected to the first member, a second member arranged about the first member, wherein the first member is rotatable within and relative to the second member, and an outer transceiver connected to the second member, wherein the outer transceiver is positioned proximate to the inner transceiver in an axial direction such that rotation of the inner transceiver induces a current within the outer transceiver to transmit at least one of power and data between the inner transceiver and the outer transceiver. At least one of the inner transceiver and the outer transceiver includes at least one nanocrystalline tape to enable the transmission of the at least one of power and data.

### CROSS REFERENCE TO RELATED APPLICATIONS

This application claims the benefit of an earlier filing date from U.S. Provisional Application Ser. No. 62/886,648, filed Aug. 14, 2019, the entire disclosure of which is incorporated herein by reference.

### BACKGROUND

### 1. Field of the Invention

The present invention generally relates to drilling systems and more particularly to power and signal transmission systems for use with drilling systems.

### 2. Description of the Related Art

To obtain hydrocarbons such as oil and gas, boreholes or wellbores are typically drilled by rotating a drill bit or other disintegrating device attached to the bottom of a drilling assembly (also referred to herein as a “Bottom Hole Assembly” or “BHA”). The drilling assembly is attached to the bottom of a tubing, which may be a jointed rigid pipe or a relatively flexible spoolable tubing commonly referred to in the art as “coiled tubing.” The string comprising the tubing and the drilling assembly is usually referred to as the “drill string.” When jointed pipe is utilized as the tubing, the drill bit is rotated by rotating the jointed pipe from the surface and/or by a mud motor contained in the drilling assembly. In the case of a coiled tubing, the drill bit is rotated by a mud motor. During drilling, a drilling fluid (also referred to as “mud”) is supplied under pressure into the tubing. The drilling fluid passes through the drilling assembly and then discharges at the drill bit bottom. The drilling fluid provides lubrication to the drill bit and carries to the surface rock pieces disintegrated by the drill bit during drilling of the borehole. The mud motor is rotated by the drilling fluid passing through the drilling assembly. A drive shaft connected to the motor and the drill bit rotates the drill bit.

A substantial proportion of current drilling activity involves drilling of deviated and horizontal boreholes to more fully exploit hydrocarbon reservoirs. Such boreholes can have relatively complex well profiles. To drill such complex boreholes, drilling assemblies are utilized which include a plurality of independently operable force application members (e.g., ribs) to apply force on the borehole wall during drilling of the borehole to maintain the drill bit along a prescribed path and to alter the drilling direction. Such force application members may be disposed on the outer periphery of the drilling assembly body or on a non-rotating sleeve disposed around a rotating drive shaft. These force application members are moved radially to apply force on the borehole wall in order to guide the drill bit and/or to change the drilling direction outward by electrical devices, electro-hydraulic devices, or other mechanisms as known in the art.

In such drilling assemblies, there exists a gap between the rotating and the non-rotating sections. To reduce the overall size of the drilling assembly and to provide more power to the force application members, it is desirable to locate the devices (such as motor and pump) required to operate the force application members in the non-rotating section of the assembly. It is also desirable to locate electronic circuits and certain sensors in the non-rotating section. Thus, power must be transferred between the rotating section and the non-rotating section to operate electrically-operated devices, sensors in the non-rotating section, and/or other electrical components/elements. In some configurations, data must also be transferred between the rotating and the non-rotating sections of the drilling assembly. Sealed slip rings are often utilized for transferring power and/or data. The seals may break causing tool failures downhole.

In drilling assemblies which do not include a non-rotating sleeve as described above, it is desirable to transfer power and/or data between the rotating drill shaft and the stationary housing surrounding the drill shaft. The power transferred to the rotating shaft may be utilized to operate sensors in the rotating shaft and/or drill bit. Power and/or data transfer between rotating and non-rotating sections having a gap therebetween can also be useful in other downhole tool configurations. Accordingly, another solution is implemented as a contactless inductive coupling to transfer power and/or data between rotating and non-rotating sections of downhole oilfield tools, including drilling assemblies containing rotating and non-rotating members. Improved systems may be desirable for such wireless power and/or data transfer.

### SUMMARY

Steering assemblies, drilling systems, and methods of drilling are described. The steering assemblies include a first member, an inner transceiver connected to the first member, a second member arranged about the first member, wherein the first member is rotatable within and relative to the second member, and an outer transceiver connected to the second member, wherein the outer transceiver is positioned proximate to the inner transceiver in an axial direction such that rotation of the inner transceiver induces a current within the outer transceiver to transmit at least one of power and data between the inner transceiver and the outer transceiver. At least one of the inner transceiver and the outer transceiver includes at least one nanocrystalline tape to enable the transmission of the at least one of power and data.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 is an example of a system for performing downhole operations that can employ embodiments of the present disclosure;

FIG. 2 is a schematic illustration of a portion of a drilling assembly that may incorporate embodiments of the present disclosure;

FIG. 3 is a schematic cross-sectional illustration of a portion of a drilling assembly that may incorporate embodiments of the present disclosure;

FIG. 4 is a schematic functional diagram and illustration of operation of a drilling assembly that may incorporate embodiments of the present disclosure;

FIG. 5 is a schematic illustration of a nanocrystalline tape in accordance with an embodiment of the present disclosure;

FIG. 6 is a schematic illustration of a nanocrystalline tape in accordance with an embodiment of the present disclosure within a housing or enclosure;

FIG. 7 is a schematic illustration of a transceiver that may be part of an inductive transformer for use in a steering assembly of a downhole drilling system in accordance with an embodiment of the present disclosure; and

FIG. 8 is a schematic illustration of a transceiver that may be part of an inductive transformer for use in a steering assembly of a downhole drilling system in accordance with an embodiment of the present disclosure.

### DETAILED DESCRIPTION

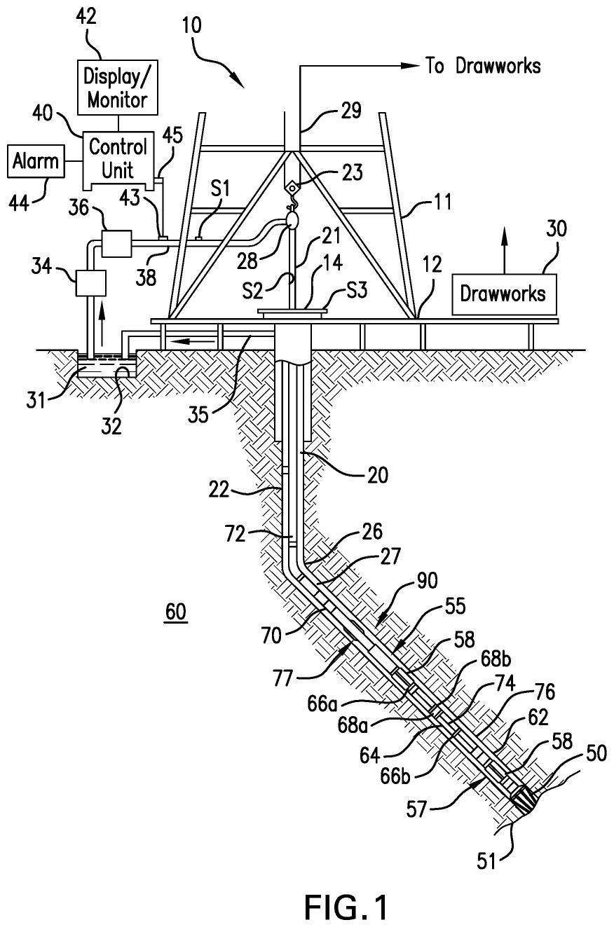

FIG. 1 shows a schematic diagram of a system for performing downhole operations. As shown, the system is a drilling system 10 that includes a drill string 20 having a drilling assembly 90, also referred to as a bottomhole assembly (BHA), conveyed in a borehole 26 penetrating an earth formation 60. The drilling system 10 includes a conventional derrick 11 erected on a floor 12 that supports a rotary table 14 that is rotated by a prime mover, such as an electric motor (not shown), at a desired rotational speed. The drill string 20 includes a drill pipe 22, or drilling tubular, extending downward from the rotary table 14 into the borehole 26. A disintegrating tool 50, such as a drill bit attached to the end of the BHA 90, disintegrates the geological formations when it is rotated to drill the borehole 26. The drill string 20 is coupled to surface equipment such as systems for lifting, rotating, and/or pushing, including, but not limited to, a drawworks 30 via a kelly joint 21, swivel 28 and line 29 through a pulley 23. In some embodiments, the surface equipment may include a top drive (not shown). During the drilling operations, the drawworks 30 is operated to control the weight on bit, which affects the rate of penetration. The operation of the drawworks 30 is well known in the art and is thus not described in detail herein.

During drilling operations a suitable drilling fluid 31 (also referred to as the “mud”) from a source or mud pit 32 is circulated under pressure through the drill string 20 by a mud pump 34. The drilling fluid 31 passes into the drill string 20 via a desurger 36, fluid line 38 and the kelly joint 21. The drilling fluid 31 is discharged at the borehole bottom 51 through an opening in the disintegrating tool 50. The drilling fluid 31 circulates uphole through the annular space 27 between the drill string 20 and the borehole 26 and returns to the mud pit 32 via a return line 35. A sensor S1 in the fluid line 38 provides information about the fluid flow rate. A surface torque sensor S2 and a sensor S3 associated with the drill string 20 respectively provide information about the torque and the rotational speed of the drill string. Additionally, one or more sensors (not shown) associated with line 29 are used to provide information about the hook load of the drill string 20 and about other desired parameters relating to the drilling of the borehole 26. The system may further include one or more downhole sensors 70 located on the drill string 20 and/or the BHA 90.

In some applications the disintegrating tool 50 is rotated by only rotating the drill pipe 22. However, in other applications, a drilling motor 55 (mud motor) disposed in the drilling assembly 90 is used to rotate the disintegrating tool 50 and/or to superimpose or supplement the rotation of the drill string 20. In either case, the rate of penetration (ROP) of the disintegrating tool 50 into the borehole 26 for a given formation and a drilling assembly largely depends upon the weight on bit and the drill bit rotational speed. In one aspect of the embodiment of FIG. 1, the mud motor 55 is coupled to the disintegrating tool 50 via a drive shaft (not shown) disposed in a bearing assembly 57. The mud motor 55 rotates the disintegrating tool 50 when the drilling fluid 31 passes through the mud motor 55 under pressure. The bearing assembly 57 supports the radial and axial forces of the disintegrating tool 50, the downthrust of the drilling motor and the reactive upward loading from the applied weight on bit. Stabilizers 58 coupled to the bearing assembly 57 and other suitable locations act as centralizers for the lowermost portion of the mud motor assembly and other such suitable locations.

A surface control unit 40 receives signals from the downhole sensors 70 and devices via a transducer 43, such as a pressure transducer, placed in the fluid line 38 as well as from sensors S1, S2, S3, hook load sensors, RPM sensors, torque sensors, and any other sensors used in the system and processes such signals according to programmed instructions provided to the surface control unit 40. The surface control unit 40 displays desired drilling parameters and other information on a display/monitor 42 for use by an operator at the rig site to control the drilling operations. The surface control unit 40 contains a computer, memory for storing data, computer programs, models and algorithms accessible to a processor in the computer, a recorder, such as tape unit, memory unit, etc. for recording data and other peripherals. The surface control unit 40 also may include simulation models for use by the computer to processes data according to programmed instructions. The control unit responds to user commands entered through a suitable device, such as a keyboard. The control unit 40 is adapted to activate alarms 44 when certain unsafe or undesirable operating conditions occur.

The drilling assembly 90 also contains other sensors and devices or tools for providing a variety of measurements relating to the formation surrounding the borehole and for drilling the borehole 26 along a desired path. Such devices may include a device for measuring the formation resistivity near and/or in front of the drill bit, a gamma ray device for measuring the formation gamma ray intensity and devices for determining the inclination, azimuth and position of the drill string. A formation resistivity tool 64, made according an embodiment described herein may be coupled at any suitable location, including above a lower kick-off subassembly 62, for estimating or determining the resistivity of the formation near or in front of the disintegrating tool 50 or at other suitable locations. An inclinometer 74 and a gamma ray device 76 may be suitably placed for respectively determining the inclination of the BHA and the formation gamma ray intensity. Any suitable inclinometer and gamma ray device may be utilized. In addition, an azimuth device (not shown), such as a magnetometer or a gyroscopic device, may be utilized to determine the drill string azimuth. Such devices are known in the art and therefore are not described in detail herein. In the above-described exemplary configuration, the mud motor 55 transfers power to the disintegrating tool 50 via a hollow shaft that also enables the drilling fluid to pass from the mud motor 55 to the disintegrating tool 50. In an alternative embodiment of the drill string 20, the mud motor 55 may be coupled below the formation resistivity tool 64 or at any other suitable place.

Still referring to FIG. 1, other logging-while-drilling (LWD) devices (generally denoted herein by numeral 77), such as devices for measuring formation porosity, permeability, density, rock properties, fluid properties, etc. may be placed at suitable locations in the drilling assembly 90 for providing information useful for evaluating the subsurface formations along borehole 26. Such devices may include, but are not limited to, temperature measurement tools, pressure measurement tools, borehole diameter measuring tools (e.g., a caliper), acoustic tools, nuclear tools, nuclear magnetic resonance tools and formation testing and sampling tools.

The above-noted devices transmit data to a downhole telemetry system 72, which in turn transmits the received data uphole to the surface control unit 40. The downhole telemetry system 72 also receives signals and data from the surface control unit 40 including a transmitter and transmits such received signals and data to the appropriate downhole devices. In one aspect, a mud pulse telemetry system may be used to communicate data between the downhole sensors 70 and devices and the surface equipment during drilling operations. A transducer 43 placed in the fluid line 38 (e.g., mud supply) detects the mud pulses responsive to the data transmitted by the downhole telemetry 72. Transducer 43 generates electrical signals in response to the mud pressure variations and transmits such signals via a conductor 45 to the surface control unit 40. In other aspects, any other suitable telemetry system may be used for two-way data communication (e.g., downlink and uplink) between the surface and the BHA 90, including but not limited to, an acoustic telemetry system, an electro-magnetic telemetry system, an optical telemetry system, a wired pipe telemetry system which may utilize wireless couplers or repeaters in the drill string or the borehole. The wired pipe may be made up by joining drill pipe sections, wherein each pipe section includes a data communication link that runs along the pipe. The data connection between the pipe sections may be made by any suitable method, including but not limited to, hard electrical or optical connections, induction, capacitive, resonant coupling, or directional coupling methods. In case a coiled-tubing is used as the drill pipe 22, the data communication link may be run along a side of the coiled-tubing.

The drilling system described thus far relates to those drilling systems that utilize a drill pipe to conveying the drilling assembly 90 into the borehole 26, wherein the weight on bit is controlled from the surface, typically by controlling the operation of the drawworks. However, a large number of the current drilling systems, especially for drilling highly deviated and horizontal boreholes, utilize coiled-tubing for conveying the drilling assembly downhole. In such application a thruster is sometimes deployed in the drill string to provide the desired force on the drill bit. Also, when coiled-tubing is utilized, the tubing is not rotated by a rotary table but instead it is injected into the borehole by a suitable injector while the downhole motor, such as mud motor 55, rotates the disintegrating tool 50. For offshore drilling, an offshore rig or a vessel is used to support the drilling equipment, including the drill string.

Still referring to FIG. 1, a formation resistivity tool 64 may be provided that includes, for example, a plurality of antennas including, for example, transmitters 66a or 66b and/or receivers 68a or 68b. Resistivity can be one formation property that is of interest in making drilling decisions. Those of skill in the art will appreciate that other formation property tools can be employed with or in place of the formation resistivity tool 64.

Although FIG. 1 is shown and described with respect to a drilling operation, those of skill in the art will appreciate that similar configurations, albeit with different components, can be used for performing different downhole operations. For example, wireline, coiled tubing, and/or other configurations can be used as known in the art. Further, production configurations can be employed for extracting and/or injecting materials from/into earth formations. Thus, the present disclosure is not to be limited to drilling operations but can be employed for any appropriate or desired downhole operation(s).

In general, embodiments of the present disclosure provide apparatuses and methods for power and/or data transfer over a nonconductive gap between rotating and non-rotating members of downhole oilfield tools. The gap may contain a non-conductive fluid, such as drilling fluid or oil for operating hydraulic devices in the downhole tool. The downhole tool, in one non-limiting embodiment, is a drilling assembly wherein a drive shaft is rotated by a downhole motor to rotate a drill bit attached to the bottom end of the drive shaft. A substantially non-rotating sleeve around the drive shaft includes a plurality of independently-operated force application members. Each such force application member is adapted to be moved radially between a retracted position and an extended position. The force application members are operated to exert the force required to maintain and/or alter a drilling direction of the downhole tool. In an example system, a common or separate electrically-operated hydraulic unit may be configured to provide energy (e.g., power) to the force application members. An inductive coupling transfer device is configured to transfer electrical power and/or data between the rotating and non-rotating members. An electronic control circuit or unit associated with the rotating member is configured to control the transfer of power and/or data between the rotating member and the non-rotating member. An electrical control circuit or unit carried by the non-rotating member is configured to control power to the devices in the non-rotating member and also to control the transfer of data from sensors and devices carried by the non-rotating member to the rotating member.

In some embodiments of the present disclosure, an inductive coupling device can be configured to transfer power and/or data from a non-rotating housing to a rotating drill shaft. The electrical power transferred to the rotating drill shaft can be utilized to operate one or more sensors in the drill bit and/or a bearing assembly. A control circuit near the drill bit may be configured to control transfer of data from the sensors in the rotating member to the non-rotating housing.

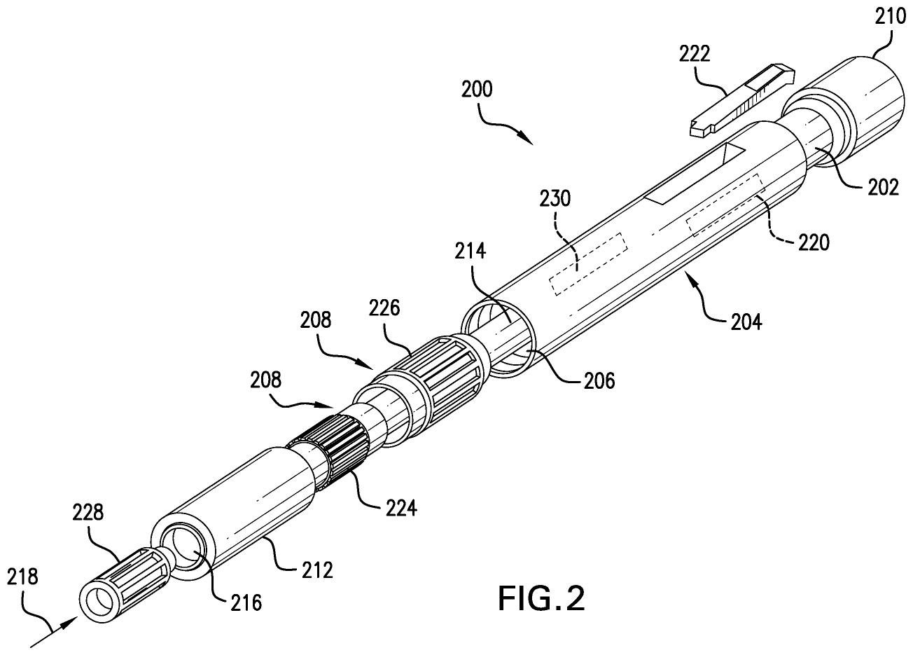

FIG. 2 is an isometric schematic illustration of a steering assembly 200 of a drilling assembly for use with a drilling system as described above. The steering assembly 200 may be part of a BHA or other system, and may be integrated into, part of, or otherwise attached to/connected to a drill string. FIG. 2 illustrates the relative position of a rotating drive shaft 202 (rotating member) and a non-rotating sleeve 204 (non-rotating member) with a non-conductive gap 206 therebetween and an electric power and/or data transfer device 208 for transferring power and/or data between the rotating drive shaft 202 and the non-rotating sleeve 204 over the non-conductive gap 206.

As noted, the steering assembly 200 may be part of a drilling assembly, and in some embodiments may form the lowermost part of the drilling assembly (i.e., located at the bottom of a borehole during operation). The rotating drive shaft 202 has a lower drill bit section 210 and an upper mud motor connection section 212. A reduced diameter hollow shaft 214 connects the sections 210 and 212. The rotating drive shaft 202 has a through bore 216 which forms a passageway for drilling fluid 218 supplied under pressure to the steering assembly 200 from a surface location. The upper mud motor connection section 212 is coupled to a power section of a drilling motor or mud motor (not shown) via a flexible shaft (not shown), as will be appreciated by those of skill in the art. In some configurations, a rotor in the drilling motor rotates the flexible shaft, which in turn rotates the rotating drive shaft 202. The lower drill bit section 210 houses a drill bit (not shown) and rotates as the rotating drive shaft 202 rotates.

The non-rotating sleeve 204 is disposed around the rotating drive shaft 202 between the upper mud motor connection section 212 and the lower drill bit section 210. It will be appreciated that although called a “non-rotating sleeve,” during drilling, the non-rotating sleeve 204 may not be completely stationary but may rotate at a low rotational speed relative to the rotation of the rotating drive shaft 202. For example, the drill shaft may rotate at 100-600 revolutions per minute (RPM) while the non-rotating sleeve 204 may rotate at less than 2 RPM. Thus, the non-rotating sleeve 204 is substantially non-rotating with respect to the rotating drive shaft 202 and is, therefore, referred to herein as a substantially non-rotating or non-rotating member, section, component, or element of the steering assembly 200. The non-rotating sleeve 204, as shown, includes at least one device 220, such as an electronic control element, that requires electric power. In the configuration of FIG. 2, the device 220 is configured to operate or control operation of one or more force application members 222.

The electric power and/or data transfer device 208 includes an inner transceiver 224 attached to an outside periphery of the rotating drive shaft 214 and an outer transceiver 226 attached to the inside of the non-rotating sleeve 204. In the steering assembly 200, the inner transceiver 224 and the outer transceiver 226 are aligned (e.g., axially overlap) and are separated by an air gap between the inner and outer transceivers 224, 226. The outer dimensions of the inner transceiver 224 are smaller than the inner dimension of the outer transceiver 226. Accordingly, the non-rotating sleeve 204, with the outer transceiver 226 attached thereto, can slide over the inner transceiver 224 (i.e., move axially relative to the inner transceiver 224). The inner transceiver 224 and the outer transceiver 226 may be inductively coupled to enable data and/or power transfer therebetween. It will be appreciated that, in some configurations, data and/or power may be transmitted bi-directionally between the inner and outer transceivers 224, 226. In a typical configuration power and/or data may be transmitted from the inner transceiver 224 to the outer transceiver 226 and power and/or data may be transmitted from the outer transceiver 226 to the inner transceiver 224.

A primary electronics element 228 in the rotating drive shaft 202 can provide electric power to the inner transceiver 224 to be transmitted or transferred to the outer transceiver 226. Further, the primary electronics element 228 can be configured to control operation of the inner transceiver 224. Moreover, the primary electronics element 228 may be configured to provide data and control signals to the inner transceiver 224, which in turn can transfer the electric power and/or data to the outer transceiver 226.

As shown, a secondary electronics element 230 is arranged on, in, or carried by the non-rotating sleeve 204. The secondary electronics element 230 is configured to receive electric energy and/or day from the outer transceiver 226. The secondary electronics element 230 can be configured to control the operation of the device 220 in the non-rotating sleeve 204 (i.e., send control signals thereto). In some embodiments, the secondary electronics element 230 and the device 220 may be a single electronics element or package. The secondary electronics element 230 may be configured to receive measurement signals from one or more sensors in the non-rotating sleeve 204. The secondary electronics element 230 can be configured to generate signals which are transferred to the primary electronics element 228 via an inductive coupling of the electric power and/or data transfer device 208 (i.e., between the inner transceiver 224 and the outer transceiver 226). The transfer of electric power and/or data between the rotating and non-rotating members are described herein.

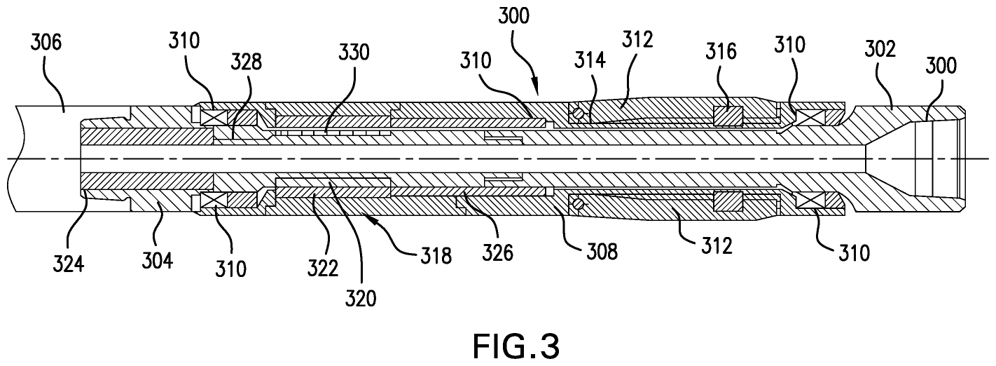

Turning now to FIG. 3, a schematic diagram of a bearing assembly 300 of a drilling assembly or steering assembly is shown. The bearing assembly 300 has a drive shaft 302 which is attached at its upper end 304 to a coupling 306, which in turn is attached to a flexible rod (not shown) that is rotated by a mud motor in the drilling assembly. A non-rotating sleeve 308 is arranged around a section of the drive shaft 302. The bearing assembly 300 includes a plurality of bearings 310 arranged or configured to provide radial and axial support to the drive shaft 302 during drilling of the wellbore. The non-rotating sleeve 308 houses a plurality of expandable force application members 312 (e.g., ribs or other extendable members). The expandable force application members 312 are arranged or housed within respective cavities 314 that are arranged about an exterior of the non-rotating sleeve 308. The cavities 314 can be configured to house various electro-hydraulic components for radially expanding the expandable force application members 312. For example, the electro-hydraulic components may include a motor that drives a pump, which supplies fluid under pressure to a piston 316 that moves the expandable force application member 312 radially outward.

An inductive coupling assembly 318 transfers electric power and/or data between the rotating and non-rotating members. The inductive coupling assembly 318 includes an inner transceiver 320 carried by the drive shaft 302 and an outer transceiver 322 carried by the non-rotating sleeve 308. The inductive coupling assembly 318, in some embodiments, may be configured such that both the inner transceiver 320 and the outer transceiver 322 each include suitable coils, as known in the art.

The bearing assembly 300 can include primary electronics elements 324 that may be, preferably, configured within in the coupling 306. However, in some embodiments, other sections of the bearing assembly 300 (e.g., parts of the drive shaft 302 which is a rotating component) may also be utilized for housing part or all of the primary electronics elements 324. As shown, secondary electronics elements 326 are arranged adjacent to the outer transceiver 322. Conductors and communication links 328 may be arranged in or along the drive shaft 302 to transfer power and/or data between the primary electronics elements 324 and the inner transceiver 320. Power may be generated using a turbine rotated by drilling fluid supplied under pressure to the drilling assembly, as known in the art. Power may also be supplied from the surface via electrical lines in the tubing. Further, alternative or other mechanisms for power generation may be employed without departing from the scope of the present disclosure. The transmission of data and/or power between the inner transceiver 320 and the outer transceiver 322 may be across a fluid gap 330, and thus the inductive coupling assembly 318 can provide wireless transmission of power and/or data.

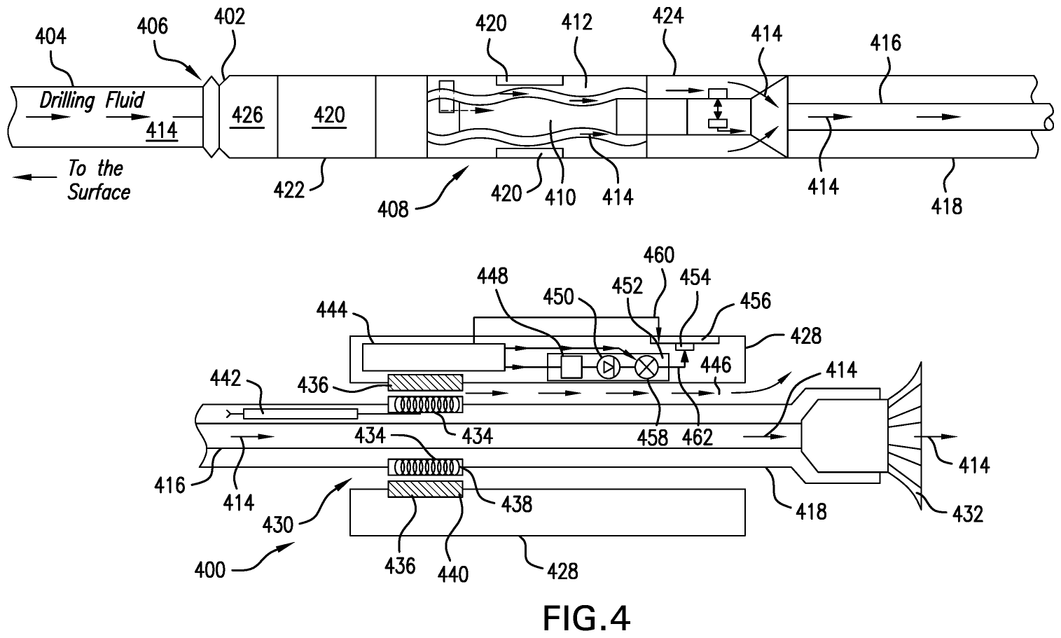

FIG. 4 illustrates a functional diagram of a drilling assembly 400 that depicts a method/configuration for power and/or data transfer between a rotating section or component and non-rotating section or component of the drilling assembly 400. Drilling assemblies or BHAs used for drilling wellbores and for providing various measurements-while-drilling measurements are well known in the art and, therefore, the detailed layout or functions thereof are not described herein. The description given below is primarily in the context of transferring electric power and/or data between rotating and non-rotating members.

The drilling assembly 400, as shown, is coupled at a top end or uphole end 402 to a tubing 404 via a coupling device 406. The tubing 404, which may be a jointed pipe or a coiled tubing, along with the drilling assembly 400 is conveyed from a surface rig into a borehole that is being drilled using the drilling assembly 400. The drilling assembly 400 includes a mud motor 408 that has a rotor 410 inside a stator 412. Drilling fluid 414 supplied under pressure to the tubing 404 passes through the mud motor 408 (e.g., a power section thereof) which rotates the rotor 410. The rotor 410 drives a flexible coupling shaft 416, which in turn rotates a drive shaft 418. A variety of measurement-while-drilling (“MWD”) or logging-while-drilling sensors (“LWD”), generally referenced as sensors 420, carried by the drilling assembly 400, provide measurements for various parameters, including, but not limited to, borehole parameters, formation parameters, and drilling assembly health parameters. The sensors 420 may be placed in a separate section, such as a section 422, or may disposed in one or more sections of the drilling assembly 400. As shown, some of the sensors 420 are placed in, mounted to, or otherwise carried on a housing 424 of the drilling assembly 400.

Electric power may be generated by a turbine 426 driven by the drilling fluid 414. Electric power also may be supplied from the surface via appropriate conductors, as known in the art. As shown in FIG. 4, the drive shaft 418 is a rotating member and a sleeve 428 is a non-rotating member arranged about the drive shaft 418. A power and/or data transfer device 430 is arranged within and as part of the drilling assembly 400. As shown, the power and/or data transfer device 430 is arranged proximate a disintegrating device 432 (e.g., a drill bit) at a distal end of the drilling assembly 400. The power and/or data transfer device 430 may be part of a steering unit or steering assembly of the drilling assembly 400.

The power and/or data transfer device 430 is arranged as an inductive transformer and includes an inner transceiver 434 carried by the drive shaft 418 (rotating member) and an outer transceiver 436 carried by or part of the sleeve 428 opposite from and arranged proximate the inner transceiver 434. The inner transceiver 434 and the outer transceiver 436, respectively, contain coils 438 and 440. Power to the coils 438 of the inner transceiver 434 may be supplied by primary electronics elements 442. The turbine 426 generates AC voltage. The primary electronics elements 442 conditions the AC voltage and supplies such power to the coils 438 of the inner transceiver 434. The rotation of the drive shaft 418 induces current into the outer transceiver 436, which delivers AC voltage as an output to secondary electronics elements 444. The secondary electronics elements 444 in the sleeve 428 are configured to convert the AC voltage from the outer transceiver 436 to DC voltage.

The DC voltage may be utilized to operate various electronic components in the secondary electronics elements 444 and/or any other electrically-operated devices on or connected to the sleeve 428. In operation, the drilling fluid 414 may fill a gap 446 between the drive shaft 418 (e.g. a rotating member) and the sleeve 428 (e.g., a non-rotating member).

A sleeve motor 448 may be operated by the secondary electronics elements 444 to drive a pump 450, which supplies a working fluid, such as oil, from a source 452 to a piston 454. The piston 454 may be operably connected to an expandable force application member 456. The piston 454 may be configured to move, urge, or otherwise actuate an associated expandable force application member 456. Movement of the expandable force application member 456 may be radially outward from the sleeve 428 to exert force on a borehole wall. The pump speed of the pump 450 may be controlled or modulated to control the force applied by the expandable force application member 456 on the borehole wall. Alternatively, as shown, a fluid flow control valve 458 in a hydraulic line 462 associated with the piston 454 may be utilized to control the supply of fluid to the piston 454 and thereby the force applied by the expandable force application member 456. The secondary electronics elements 444 may be configured to control operation of the flow control valve 458. In a non-limiting example configuration, a plurality of spaced apart expandable force application members 456 (e.g., three) are carried by the sleeve 428, with each expandable force application member 456 being independently operated by common or separate secondary electronics elements 444.

In some embodiments, and as shown, the secondary electronics elements 444 can receive signals from sensors 460 that are located on the sleeve 428. At least one of the sensors 460 can provide measurements indicative of the force applied by the expandable force application member(s) 456. Each expandable force application member 456, when multiple are employed, may have an individual corresponding sensor. The secondary electronics elements 444 may condition the signals from the sensors 460 and may compute values of corresponding parameters and supply data signals indicative of such parameters to the outer transceiver 436, which may transfer such data signals to the inner transceiver 434. In some configurations, separate transceivers (or transmitter/receiver configurations) may be utilized for transferring data from the sleeve 428 to the drive shaft 418 as compared to transferring data/power from the drive shaft 418 to the sleeve 428. Frequency modulating techniques, known in the art, may be utilized to transfer signals between the transceivers 434, 436. The signals from the primary electronics elements 442 may include command signals for controlling the operation of devices in the sleeve 428.

The transceivers described above are implemented using magnetic materials, such as ferrite, to form the inductive transformers. The rotation of the inner transceiver is configured to induce a current within the stationary (outer) transceiver to thus enable the transmission of data and/or power from the rotating inner transceiver and the (relatively) stationary outer transceiver. These inductive transformers in steering units for downhole use typically employ relatively fragile ferrite cores (e.g., bricks) to generate the electromagnetic field and transmit power and/or data, as described above. The ferrite cores must be maintained at small radial thicknesses due to the brittleness of the material. As such, relatively long (axial length) cannot be used.

Due to the various forces and environments, the brittle ferrite cores may crack or otherwise become damaged, which can lead to high maintenance costs, scrap costs, and sometimes to tool failures. For example, because the ferrite cores are arranged within a steering device, various bending loads may be applied during operation, along with high pressures, high temperatures, and rotational speeds (for the rotating parts). Further, adhesives (e.g., glue) used to attach the ferrite cores to a frame of the inductive transformer may form cavities, which can lead to failures due to expansion and/or material failures.

Accordingly, embodiments provided here are directed to improved systems for data and/or power transmission for inductive transformers of downhole steering units.

Embodiments of the present disclosure are directed to nanocrystalline tapes that can provide similar functionality as the ferrite cores, but may, for example, reduce or eliminate the failures associated therewith. Other benefits and/or features may be provided by use of nanocrystalline tapes described herein. For example, the use of nanocrystalline tapes may increase the lifetime of downhole components (e.g., parts of steering assemblies) and make such components more reliable and reduce maintenance cycles. This is achieved, in part, because the nanocrystalline tapes are relatively flexible as compared to ferrite cores and can withstand mechanical loads better than the ferrite cores of prior systems. For example, such flexibility may be achieved, in part, due to glued layers of material to form a tape. Even when stacked to form a core, the tape-based configurations described herein provide flexibility over ferrite cores, and can withstand bending loads more effectively. The nanocrystalline tapes described herein may be applied to a carrier in various different configurations (e.g., stacked, wrapped, etc.) and further can be cut/formed to different lengths/widths and stacked to provide for a given desired height, width, and/or length application. As such, the tapes described herein may be employed in a variety of different configurations not previously achievable with ferrite cores.

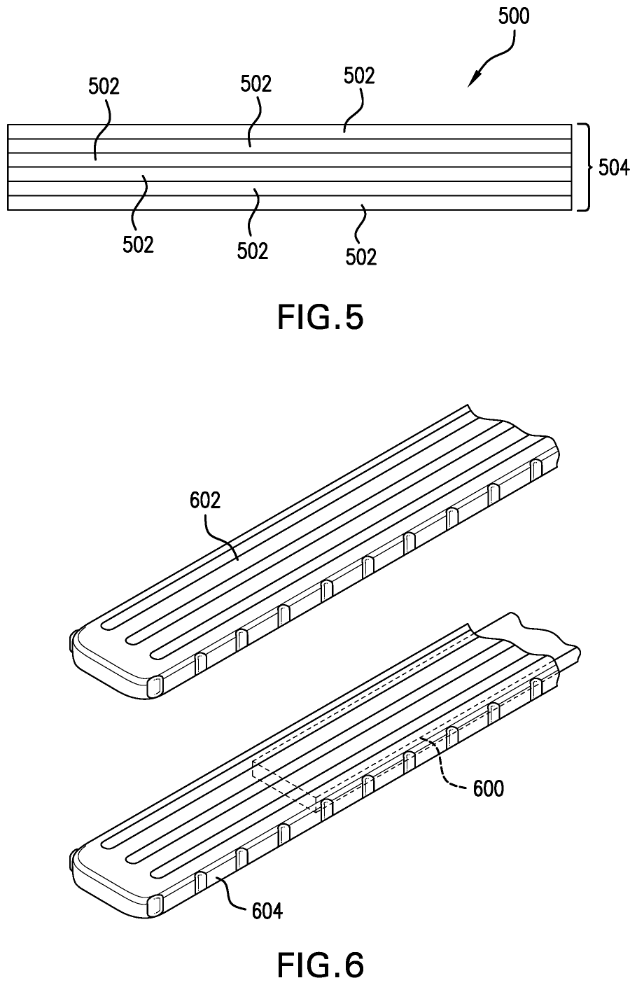

Turning now to FIG. 5, a schematic illustration of a nanocrystalline tape 500 in accordance with an embodiment of the present disclosure is shown. The nanocrystalline tape 500 may be installed into an inductive transformer frame, as described herein, to provide a magnetic component for enabling wireless power and/or data transfer between a rotating component (e.g., a drive shaft) and a non-rotating component (e.g., a sleeve) of, for example, a steering assembly of a downhole drilling system. The nanocrystalline tape 500 is formed from one or more tape layers 502 that are stacked to form a core stack 504, with the core stack 504 being a flexible tape. Each of the tape layers 502 may be bonded to adjacent tape layers 502 by an adhesive. Each tape layer 502 is formed of a nanocrystalline material. A nanocrystalline material is a polycrystalline material with a crystallite size of only a few nanometers. These materials fill the gap between amorphous materials without any long range order and conventional coarse-grained materials. Although definitions may vary, nanocrystalline materials as employed in some non-limiting embodiments have a crystallite (grain) size below 100 nm, for example, less than 95 nm, less than 90 nm, less than 85 nm, less than 80 nm, or less than 75 nm. In other embodiments, other grain sizes, such as slightly over 100 nm may be employed (e.g., 100-500 nm grain size), for example, 100-150 nm, 150-200 nm, 200-250 nm, 250-300 nm, 300-350 nm, 350-400 nm, 400-450 nm, or 450-500 nm. The materials selective for the tape layers 502 may be any desirable material. For example, some such materials may be magnetic metals and/or magnetic alloys, which may be iron-based.

In one non-limiting example, the nanocrystalline tape 500 is formed from an iron alloy arranged as laminated tape strips or layers (the tape layers 502). Each tape layer 502 may have a thickness of about 20 μm with an 80-90% effective cross-section. An interlayer insulation and bonding may be provided by an oxide and epoxy having a thickness of about 2-4 μm, for example, 2.5 μm, 3 μm, or 3.5 μm. These thin tape layers can provide for the desired flexibility to withstand bending loads along with other conditions experienced downhole by an inductive transformer of a steering assembly in a downhole drilling system.

FIG. 6 illustrates a nanocrystalline tape 600 in accordance with an embodiment of the present disclosure. In this embodiment, the nanocrystalline tape 600 is housed within a tape housing 602, 604, with a top enclosure 602 joinable to a bottom enclosure 604. The tape housing 602, 604 may be configured to protect the nanocrystalline tape 600 from external environments (e.g., downhole conditions, fluids, etc.). When contained within the tape housing 602, 604, the nanocrystalline tape 600 may be mounted to and/or affixed to an inductive transformer frame. The enclosures 602, 604 may be formed from an elastomeric material that is selected to protect the nanocrystalline tape 600 from the external environmental and may be configured to ease the mounting of the nanocrystalline tape 600 to an inductive transformer frame. In one non-limiting embodiment, the tape housing 602, 604 illustratively shown in FIG. 6 may be replaced by a fiberglass wrap that is directly wrapped about the nanocrystalline tape 600. Although elastomeric and fiberglass materials are described herein, various other materials may be employed without departing from the scope of the present disclosure.

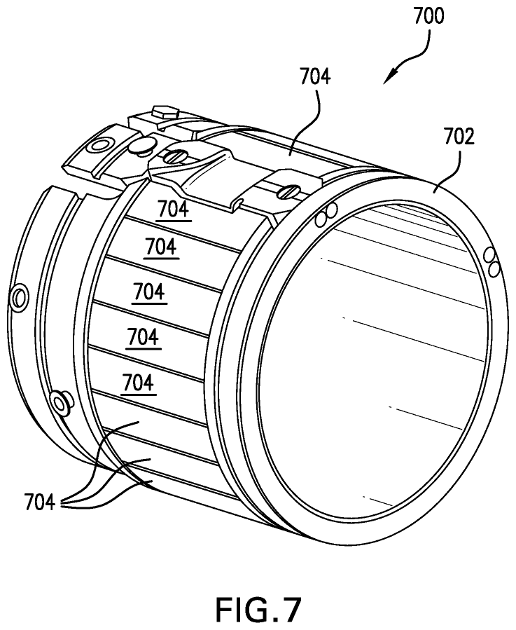

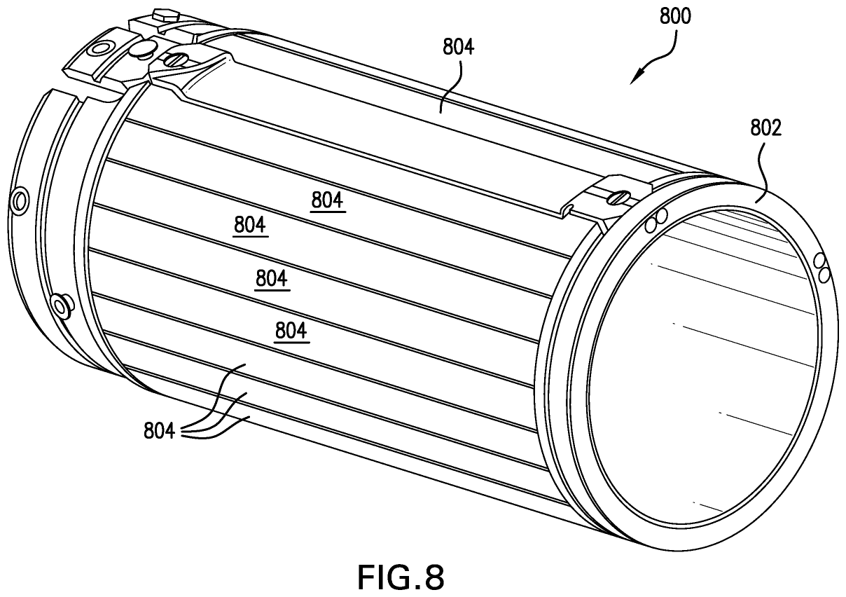

Turning now to FIG. 7, a transceiver 700 in accordance with an embodiment of the present disclosure is shown. The transceiver 700 may be part of an inductive transformer for use in a steering assembly of a downhole drilling system, as shown and described above. The transceiver 700 shown in FIG. 7 is representative of an inner transceiver (as described above), but those of skill in the art will appreciate that a similar structure may be employed for use with an outer transceiver of an inductive transformer.

The transceiver 700 includes an inductive transformer frame 702 that is attachable or mountable to a drive shaft. The inductive transformer frame 702 is configured to receive and house one or more nanocrystalline tapes 704. The nanocrystalline tapes 704 may be arranged about a circumference of the inductive transformer frame 702 to form a substantially circular or cylindrical configuration which may be arranged to be rotated to induce a current within a stationary or substantially stationary transceiver that is arranged radially outward from the nanocrystalline tapes 704 of the transceiver 700.

FIG. 8 is illustrative of a transceiver 800 having an inductive transformer frame 802 similar to that shown in FIG. 7. FIG. 8 is illustrative of the versatility enabled through application of nanocrystalline tapes 804 of the present disclosure, which can be mounted to or affixed to the inductive transformer frame 802. As shown, the length of the nanocrystalline tapes 804 may be varied and selected for a desired application, enabling longer inductive transformers as compared to prior configurations that employed ferrite cores. In some embodiments, the length of the nanocrystalline tapes 804 (e.g., in an axial direction along an inductive transformer frame) may be 400 mm or greater, for example, 400-450 mm, 450-500 mm, or 500-600 mm, although shorter lengths are possible with the flexibility of such nanocrystalline tapes, for example, 200-300 mm, 300-350 mm, or 350-400 mm.

Advantageously, embodiments described herein enable the transmission of data and/or power within steering assemblies of downhole drilling systems. The nanocrystalline tapes of the present disclosure can increase the lifetime of an inductive transformer used in steering units and assemblies of downhole drilling systems. Further, due to the avoidance of gaps (e.g., like those that exist between the ferrite cores) it may be possible to reduce the size of an inductive transformer within the systems. Moreover, increased axial length of such inductive transformers using nanocrystalline tapes may enable a reduction in radial dimension, thus narrowing the components of the steering assembly.

Other benefits and/or features may be provided by use of nanocrystalline tapes described herein. For example, the use of nanocrystalline tapes may increase the lifetime of downhole components (e.g., parts of steering assemblies) and make such components more reliable and reduce maintenance cycles. This is achieved, in part, because the nanocrystalline tapes are relatively flexible as compared to ferrite cores and can withstand mechanical loads better than the ferrite cores of prior systems. For example, such flexibility may be achieved, in part, due to glued layers of material to form a tape. Even when stacked to form a core, the tape-based configurations described herein provide flexibility over ferrite cores, and can withstand bending loads more effectively. The nanocrystalline tapes described herein may be applied to a carrier in various different configurations (e.g., stacked, wrapped, etc.) and further can be cut/formed to different lengths/widths and stacked to provide for a given desired height, width, length, and/or geometry application. As such, the tapes described herein may be employed in a variety of different configurations not previously achievable with ferrite cores.

While embodiments described herein have been described with reference to specific figures, it will be understood that various changes may be made and equivalents may be substituted for elements thereof without departing from the scope of the present disclosure. In addition, many modifications will be appreciated to adapt a particular instrument, situation, or material to the teachings of the present disclosure without departing from the scope thereof. Therefore, it is intended that the disclosure not be limited to the particular embodiments disclosed, but that the present disclosure will include all embodiments falling within the scope of the appended claims or the following description of possible embodiments.

Embodiment 1: A steering assembly for a downhole drilling system comprising: a first member; an inner transceiver connected to the first member; a second member arranged about the first member, wherein the first member is rotatable within and relative to the second member; and an outer transceiver connected to the second member, wherein the outer transceiver is positioned proximate to the inner transceiver in an axial direction such that rotation of the inner transceiver induces a current within the outer transceiver to transmit at least one of power and data between the inner transceiver and the outer transceiver, wherein at least one of the inner transceiver and the outer transceiver comprises at least one nanocrystalline tape configured to enable the transmission of the at least one of power and data.

Embodiment 2: The steering assembly of any prior embodiment, wherein the nanocrystalline tape comprises a plurality of tape layers.

Embodiment 3: The steering assembly of any prior embodiment, wherein each tape layer of the plurality of tape layers has a thickness of about 20 μm.

Embodiment 4: The steering assembly of any prior embodiment, wherein the plurality of tape layers are bonded together using an interlayer bonding material.

Embodiment 5: The steering assembly of any prior embodiment, wherein the interlayer bonding material has a thickness of about 2-4 μm.

Embodiment 6: The steering assembly of any prior embodiment, wherein the interlayer bonding material comprises an oxide and epoxy.

Embodiment 7: The steering assembly of any prior embodiment, wherein the nanocrystalline tape comprises a material having a grain size below 100 nm.

Embodiment 8: The steering assembly of any prior embodiment, wherein the nanocrystalline tape has an axial length of 400 mm or greater.

Embodiment 9: The steering assembly of any prior embodiment, wherein the nanocrystalline tape comprises an iron alloy.

Embodiment 10: The steering assembly of any prior embodiment, further comprising a tape housing, with the nanocrystalline tape arranged within the tape housing.

Embodiment 11: The steering assembly of any prior embodiment, wherein the tape housing comprises at least one of an elastomer and fiberglass.

Embodiment 12: The steering assembly of any prior embodiment, further comprising at least one expandable force application member arranged on an exterior of the non-rotating member, wherein power received at the outer transceiver is employed to operate the at least one expandable force application member.

Embodiment 13: The steering assembly of any prior embodiment, further comprising a primary electronics element arranged on the rotating member and a secondary electronics element arranged on the non-rotating member.

Embodiment 14: The steering assembly of any prior embodiment, wherein at least one of data and power is configured to be transmitted from the primary electronics element to the secondary electronics element through an interaction of the inner transceiver and the outer transceiver.

Embodiment 15: The steering assembly of any prior embodiment, wherein at least one of data and power is configured to be transmitted from the secondary electronics element to the primary electronics element through an interaction of the inner transceiver and the outer transceiver.

Embodiment 16: A drilling system comprising: a drill string having a disintegrating device at an end thereof; and a steering assembly arranged proximate the disintegrating device, the steering assembly comprising: a first member; an inner transceiver connected to the first member; a second member arranged about the first member, wherein the first member is rotatable within and relative to the second member; and an outer transceiver connected to the second member, wherein the outer transceiver is positioned proximate to the inner transceiver in an axial direction such that rotation of the inner transceiver induces a current within the outer transceiver to transmit at least one of power and data between the inner transceiver and the outer transceiver, wherein at least one of the inner transceiver and the outer transceiver comprises at least one nanocrystalline tape to enable the transmission of the at least one of power and data.

Embodiment 17: The drilling system of any prior embodiment, further comprising at least one expandable force application member arranged on an exterior of the second member, wherein power received at the outer transceiver is employed to operate the at least one expandable force application member, wherein the at least one expandable force application member is configured to enable steering of the disintegrating device.

Embodiment 18: A method for forming a wellbore in an earth formation, comprising: arranging a steering assembly on a drill string proximate a disintegrating device at an end of the drill string; disposing at least one nanocrystalline tape on at least one of an inner transceiver and an outer transceiver of the steering assembly; connecting the inner transceiver to a first member of the steering assembly; disposing a second member of the steering assembly about the first member, wherein the first member is rotatable within and relative to the second member; connecting the outer transceiver to the non-first member; positioning the outer transceiver proximate to the inner transceiver in an axial direction; rotating the inner transceiver to induce a current within the outer transceiver to transmit at least one of power and data between the inner transceiver and the outer transceiver; and drilling the wellbore.

Embodiment 19: The method of any prior embodiment, wherein the at least one nanocrystalline tape comprises a plurality of tape layers, wherein each tape layer of the plurality of tape layers has a thickness of about 20 μm.

Embodiment 20: The method of any prior embodiment, wherein the at least one nanocrystalline tape has an axial length of 400 mm or greater.

In support of the teachings herein, various analysis components may be used including a digital and/or an analog system. For example, controllers, computer processing systems, and/or geo-steering systems as provided herein and/or used with embodiments described herein may include digital and/or analog systems. The systems may have components such as processors, storage media, memory, inputs, outputs, communications links (e.g., wired, wireless, optical, or other), user interfaces, software programs, signal processors (e.g., digital or analog) and other such components (e.g., such as resistors, capacitors, inductors, and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (e.g., ROMs, RAMs), optical (e.g., CD-ROMs), or magnetic (e.g., disks, hard drives), or any other type that when executed causes a computer to implement the methods and/or processes described herein. These instructions may provide for equipment operation, control, data collection, analysis and other functions deemed relevant by a system designer, owner, user, or other such personnel, in addition to the functions described in this disclosure. Processed data, such as a result of an implemented method, may be transmitted as a signal via a processor output interface to a signal receiving device. The signal receiving device may be a display monitor or printer for presenting the result to a user. Alternatively, or in addition, the signal receiving device may be memory or a storage medium. It will be appreciated that storing the result in memory or the storage medium may transform the memory or storage medium into a new state (i.e., containing the result) from a prior state (i.e., not containing the result). Further, in some embodiments, an alert signal may be transmitted from the processor to a user interface if the result exceeds a threshold value.

Furthermore, various other components may be included and called upon for providing for aspects of the teachings herein. For example, a sensor, transmitter, receiver, transceiver, antenna, controller, optical unit, electrical unit, and/or electromechanical unit may be included in support of the various aspects discussed herein or in support of other functions beyond this disclosure.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifiers “about” and “substantially,” as used in connection with a quantity or descriptive aspect, are inclusive of the stated value and have a meaning dictated by the context (e.g., such terms include the degree of error associated with a measurement of the particular quantity or description of such aspect).

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the present disclosure.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While embodiments described herein have been described with reference to various embodiments, it will be understood that various changes may be made and equivalents may be substituted for elements thereof without departing from the scope of the present disclosure. In addition, many modifications will be appreciated to adapt a particular instrument, situation, or material to the teachings of the present disclosure without departing from the scope thereof. Therefore, it is intended that the disclosure not be limited to the particular embodiments disclosed as the best mode contemplated for carrying the described features, but that the present disclosure will include all embodiments falling within the scope of the appended claims.

Accordingly, embodiments of the present disclosure are not to be seen as limited by the foregoing description but are only limited by the scope of the appended claims.

What is claimed is:

1. A steering assembly for a downhole drilling system comprising:
a first member;
an inner transceiver connected to the first member;
a second member arranged about the first member, wherein the first member is rotatable within and relative to the second member; and
an outer transceiver connected to the second member, wherein the outer transceiver is positioned proximate to the inner transceiver in an axial direction such that rotation of the inner transceiver induces a current within the outer transceiver to transmit at least one of power and data between the inner transceiver and the outer transceiver,
wherein at least one of the inner transceiver and the outer transceiver comprises at least one nanocrystalline tape configured to enable the transmission of the at least one of power and data.

2. The steering assembly of claim 1, wherein the nanocrystalline tape comprises a plurality of tape layers.

3. The steering assembly of claim 2, wherein each tape layer of the plurality of tape layers has a thickness of about 20 μm.

4. The steering assembly of claim 2, wherein the plurality of tape layers are bonded together using an interlayer bonding material.

5. The steering assembly of claim 4, wherein the interlayer bonding material has a thickness of about 2-4 μm.

6. The steering assembly of claim 5, wherein the interlayer bonding material comprises an oxide and epoxy.

7. The steering assembly of claim 1, wherein the nanocrystalline tape comprises a material having a grain size below 100 nm.

8. The steering assembly of claim 1, wherein the nanocrystalline tape has an axial length of 400 mm or greater.

9. The steering assembly of claim 1, wherein the nanocrystalline tape comprises an iron alloy.

10. The steering assembly of claim 1, further comprising a tape housing, with the nanocrystalline tape arranged within the tape housing.

11. The steering assembly of claim 10, wherein the tape housing comprises at least one of an elastomer and fiberglass.

12. The steering assembly of claim 1, further comprising at least one expandable force application member arranged on an exterior of the non-rotating member, wherein power received at the outer transceiver is employed to operate the at least one expandable force application member.

13. The steering assembly of claim 1, further comprising a primary electronics element arranged on the rotating member and a secondary electronics element arranged on the non-rotating member.

14. The steering assembly of claim 13, wherein at least one of data and power is configured to be transmitted from the primary electronics element to the secondary electronics element through an interaction of the inner transceiver and the outer transceiver.

15. The steering assembly of claim 13, wherein at least one of data and power is configured to be transmitted from the secondary electronics element to the primary electronics element through an interaction of the inner transceiver and the outer transceiver.

16. A drilling system comprising:
a drill string having a disintegrating device at an end thereof; and
a steering assembly arranged proximate the disintegrating device, the steering assembly comprising:
a first member;
an inner transceiver connected to the first member;
a second member arranged about the first member, wherein the first member is rotatable within and relative to the second member; and
an outer transceiver connected to the second member, wherein the outer transceiver is positioned proximate to the inner transceiver in an axial direction such that rotation of the inner transceiver induces a current within the outer transceiver to transmit at least one of power and data between the inner transceiver and the outer transceiver,
wherein at least one of the inner transceiver and the outer transceiver comprises at least one nanocrystalline tape to enable the transmission of the at least one of power and data.

17. The drilling system of claim 16, further comprising at least one expandable force application member arranged on an exterior of the second member, wherein power received at the outer transceiver is employed to operate the at least one expandable force application member, wherein the at least one expandable force application member is configured to enable steering of the disintegrating device.

18. A method for forming a wellbore in an earth formation, comprising:
arranging a steering assembly on a drill string proximate a disintegrating device at an end of the drill string;
disposing at least one nanocrystalline tape on at least one of an inner transceiver and an outer transceiver of the steering assembly;
connecting the inner transceiver to a first member of the steering assembly;
disposing a second member of the steering assembly about the first member, wherein the first member is rotatable within and relative to the second member;
connecting the outer transceiver to the non-first member;
positioning the outer transceiver proximate to the inner transceiver in an axial direction;
rotating the inner transceiver to induce a current within the outer transceiver to transmit at least one of power and data between the inner transceiver and the outer transceiver; and
drilling the wellbore.

19. The method of claim 18, wherein the at least one nanocrystalline tape comprises a plurality of tape layers, wherein each tape layer of the plurality of tape layers has a thickness of about 20 μm.

20. The method of claim 19, wherein the at least one nanocrystalline tape has an axial length of 400 mm or greater.
